(19) United States
(12) Patent Application Publication
(10) Pub. No.: US 2026/0021670 A1
(43) Pub. Date: Jan. 22, 2026

(54) PRINTER

(71) Applicant: FCL COMPONENTS LIMITED, Tokyo (JP)

(72) Inventors: Tatsuya Oguchi, Tokyo (JP); Tetsuhiro Ishikawa, Tokyo (JP); Yuji Yada, Tokyo (JP); Yuuya Ishii, Tokyo (JP)

(21) Appl. No.: 19/266,553

(22) Filed: Jul. 11, 2025

(30) Foreign Application Priority Data
Jul. 16, 2024 (JP) 2024-113103

(51) Int. Cl. B41J 25/304; B41J 2/32; B41J 29/13

(52) U.S. Cl. CPC B41J 25/304; B41J 2/32; B41J 29/13

(57) ABSTRACT

In a printer according to an embodiment of the present disclosure, a head unit includes a plurality of projections which project toward the rear in conveying direction (X-axis direction) of recording paper, and with one projection provided at each location between the center and respective ends of the head unit in longitudinal direction along width direction (Y-axis direction) of the recording paper. The head frame includes notches to accommodate projections, movement restrictor which contacts a part of the head unit from both sides in the longitudinal direction of the head unit, and biasing members to bias the head unit toward the platen. Each of the notches is provided to form a space between itself and the projection, such that the head unit is allowed to swing around axis parallel to rotary shaft (the X-axis direction) of the openable-closable section and axis parallel to the width direction of the recording paper.

### CROSS-REFERENCE TO RELATED APPLICATION

This application is based upon and claims the benefit of priority of the prior Japanese Patent Application No. 2024-113103 filed on Jul. 16, 2024, the entire contents of which are incorporated herein by reference.

### BACKGROUND

A certain aspect of the embodiments is related to a printer.

Conventionally, thermal printers configured to print information on thermal paper by a thermal printhead are known. The thermal printer disclosed in Japanese Laid-Open Patent Application No. 2011-161815 includes a lid which is opened by rotationally moving the lid arranged above a main body backward with the rear end of the main body as the center of rotation. The lid is opened and closed by being rotationally moved about a rotary shaft that is parallel to a width direction of the thermal paper wound in a roll shape and stored in a paper storage of the main body.

In the thermal printer disclosed in Japanese Laid-Open Patent Application No. 2011-161815, a rear portion of a thermal printhead unit is supported by being hooked only at a substantially central position in the width direction of the thermal paper. Therefore, the thermal printhead unit has a degree of freedom to swing up and down relative to the width direction of the thermal paper with the rear supported part as the pivot center.

With this configuration, even when a platen roller to which a heating element array of the thermal printhead unit comes into contact is worn in a truncated cone shape in the width direction of the thermal paper, for example, due to a difference in the degree of wear, the thermal printhead unit is tilted in the width direction. Thus, unevenness in the width direction of the thermal paper due to uneven wear of the platen roller can be absorbed, and thus the contact between the heating element array and the platen roller in the width direction of the thermal paper can be made nearly uniform.

In addition, there is known a label printer configured to be able to switch between continuous label printing and peel-off label printing. In the printer described in Japanese Laid-Open Patent Application No. 2022-080490, internal functional components are protected by a main-body casing and a printer cover. By opening the printer cover, a roll paper storage chamber is exposed. The roll paper storage chamber is a space for storing roll paper. The printer cover can be opened and closed by rotationally moving about a hinge axis parallel to the width direction of the roll paper, between an open position for opening the inside of the printer and a closed position for closing the inside of the printer.

In the printer disclosed in Japanese Laid-Open Patent Application No. 2022-080490, a notch is provided at a substantially central position in a longitudinal direction (the width direction of the roll paper) of the surface of the thermal head. In addition, a projecting portion is formed on a wall surface facing the rear surface of the thermal head in the inner frame behind the thermal head. The projecting portion contacts the thermal head at the notch. With such a configuration, the thermal head can swing clockwise and counterclockwise with the projecting portion as a fulcrum in a plan view. Furthermore, the thermal head can swing clockwise and counterclockwise with the projecting portion as the fulcrum in a side view in the width direction of the thermal paper.

### SUMMARY

One aspect of the present disclosure is a printer including: a head unit configured to print on recording paper; a platen configured to convey the recording paper; a main body configured to support the head unit or the platen; an openable-closable section connected to the main body to be rotationally movable about a rotary shaft orthogonal in a width direction of the recording paper and configured to support the platen or the head unit unsupported by the main body; and a head frame provided on the main body or the openable-closable section configured to support the head unit, wherein the head unit includes: a plurality of projections which project toward the rear in a conveying direction of the recording paper, and with one projection provided at each location between the center and respective ends of the head unit in a longitudinal direction along the width direction of the recording paper, the head frame includes: a notch configured to accommodate the projection; a movement restrictor configured to contact a part of the head unit from both sides in the longitudinal direction; and a biasing member configured to bias the head unit toward the platen, and the notch is provided to form a space between itself and the projection to allow swinging of the head unit around an axis parallel to the rotary shaft and around an axis parallel to the width direction of the recording paper.

Another aspect of the present disclosure is a printer including: a head unit configured to print on recording paper; a platen configured to convey the recording paper; a main body configured to support the head unit or the platen; an openable-closable section connected to the main body to be rotationally movable about a rotary shaft orthogonal in a width direction of the recording paper and configured to support the platen or the head unit unsupported by the main body; and a head frame provided on the main body or the openable-closable section configured to support the head unit, wherein the head unit includes: a plurality of projections which project toward the rear in the conveying direction of the recording paper, and with one projection provided at each location between the center and respective ends of the head unit in the longitudinal direction along the width direction of the recording paper, the head frame includes: a notch configured to accommodate the projection; and a biasing member configured to bias the head unit toward the platen, and the notch is provided to form a space between itself and the projection to allow swinging of the head unit around an axis parallel to the rotary shaft and around an axis parallel to the width direction of the recording paper, and is configured to restrict the movement of the head unit in the width direction of the recording paper by contacting the projection in a state where the head unit is supported in parallel to the width direction of the recording paper.

Still another aspect of the present disclosure is a printer including: a head unit configured to print on recording paper; a platen configured to convey the recording paper; a main body configured to support the head unit or the platen; an openable-closable section connected to the main body to be rotationally movable about a rotary shaft orthogonal in a width direction of the recording paper and configured to support the platen or the head unit unsupported by the main body; and a head frame provided on the main body or the openable-closable section configured to support the head unit, wherein the head unit includes: a plurality of projections which project toward the rear in the conveying direction of the recording paper, and with one projection provided at each location between the center and respective ends of the head unit in the longitudinal direction along the width direction of the recording paper; and a projecting portion provided at each end in the longitudinal direction of the head unit; the head frame includes: a notch configured to accommodate the projection; a side wall configured to contact the projecting portion from each side in the longitudinal direction; and a biasing member configured to bias the head unit toward the platen, and the notch is provided to form a space between itself and the projection to allow swinging of the head unit around an axis parallel to the rotary shaft and around an axis parallel to the width direction of the recording paper.

### BRIEF DESCRIPTION OF THE DRAWINGS

FIG. 1 is a perspective view illustrating a printer according to a first embodiment;

FIG. 2 is a perspective view illustrating a main body and an openable-closable section;

FIG. 3 is a perspective view illustrating the main body and the openable-closable section;

FIG. 4 is a perspective view illustrating the main body and the openable-closable section;

FIG. 5 is a front view illustrating the main body and the openable-closable section;

FIG. 6 is a cross-sectional view illustrating the main body and the openable-closable section;

FIG. 7 is a front view illustrating the main body and the openable-closable section;

FIG. 8 is a rear view illustrating a head unit and a head frame;

FIG. 9 is an enlarged view illustrating a projection and a notch;

FIG. 10 is a cross-sectional view illustrating the head unit and the head frame;

FIG. 11 is a rear view illustrating the head unit and the head frame;

FIG. 12 is a rear view illustrating the head unit and the head frame;

FIG. 13 is an enlarged view illustrating a projection and a notch of a printer according to a second embodiment;

FIG. 14 is a top view illustrating the head unit and the head frame;

FIG. 15 is an enlarged view illustrating a projecting portion and a side wall;

FIG. 16 is an enlarged view illustrating a projection and a notch of a printer according to a third embodiment; and

FIG. 17 is an enlarged view illustrating a projection and a notch of a printer according to a fourth embodiment.

### DESCRIPTION OF EMBODIMENTS

Hereinafter, embodiments of the present disclosure will be described with reference to the drawings.

Unlike the above-mentioned Japanese Laid-Open Patent Application No. 2011-161815 and Japanese Laid-Open Patent Application No. 2022-080490, in a printer configured to print on recording paper between the main body and the openable-closable section provided on the main body, there is a case in which the openable-closable section is connected to the main body to be rotationally movable about a rotary shaft orthogonal to the width direction of the recording paper, so as to be openable and closable relative to the main body.

In this case, when the openable-closable section is gradually closed from a fully opened state with respect to the main body, the head unit configured to print on the recording paper and a platen configured to convey the recording paper start to contact each other from the end in the width direction of the recording paper close to the rotary shaft of the openable-closable section. Then, when the openable-closable section is further closed with respect to the main body, the range of contact between the head unit and the platen toward the end apart from the rotary shaft in the width direction of the recording paper expands. Therefore, it is difficult to make the platen and the head unit uniformly contact in the width direction of the recording paper.

Japanese Laid-Open Patent Application No. 2011-161815 and Japanese Laid-Open Patent Application No. 2022-080490 disclose that the thermal head unit or the thermal head is swingable with respect to the platen roller. However, a lid and the printer cover are respectively opened and closed with respect to the main body and the main-body casing by rotationally moving about the rotary shaft parallel to the width direction of the thermal paper and the roll paper. Therefore, when the lid and the printer cover are respectively configured to be rotationally movable about the rotary shaft orthogonal to the width direction of thermal paper and roll paper, there is a risk that the thermal head unit, the thermal head, and the platen roller do not uniformly contact each other in the width direction of thermal paper and roll paper.

Disclosed is a printer in which a head unit and a platen can uniformly contact each other in a width direction of recording paper when openable-closable sections are configured to be rotationally movable about a rotary shaft orthogonal to the width direction of recording paper with respect to a main body.

### First Embodiment

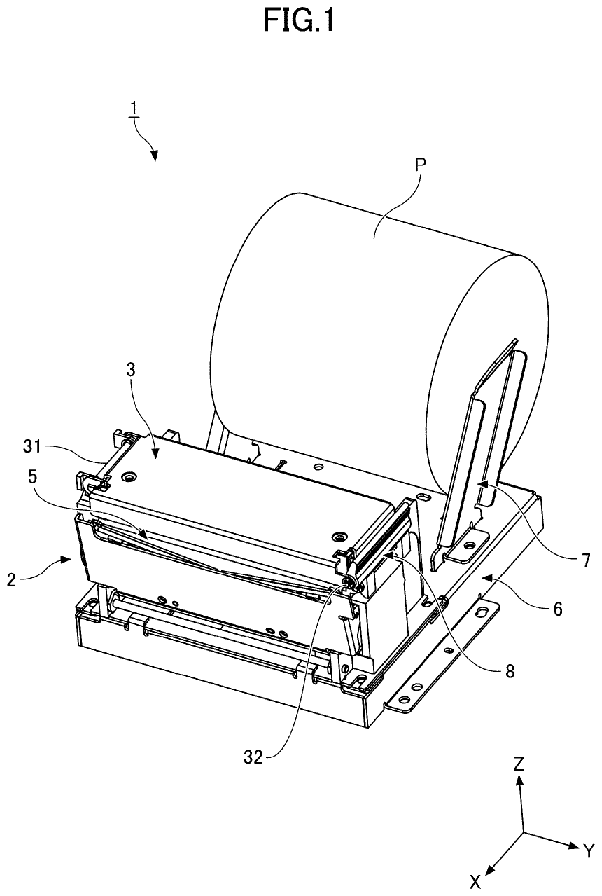

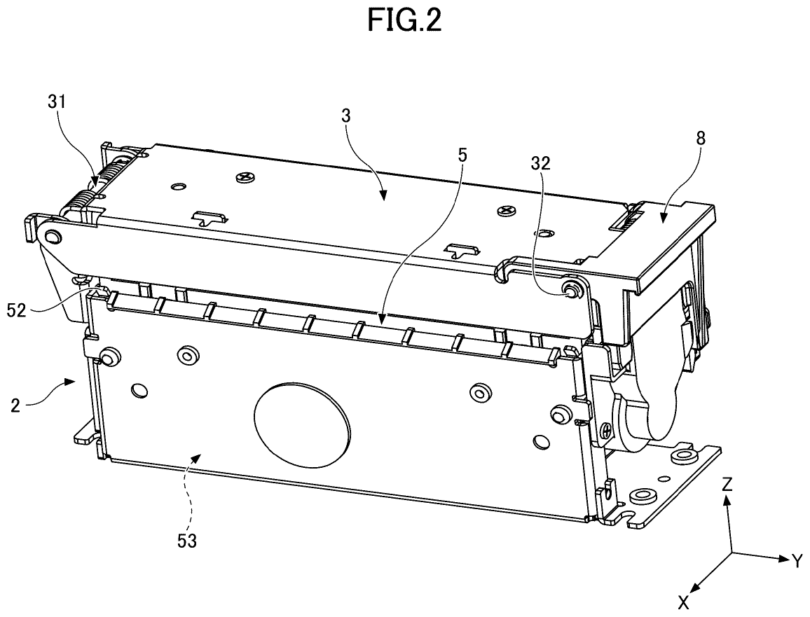

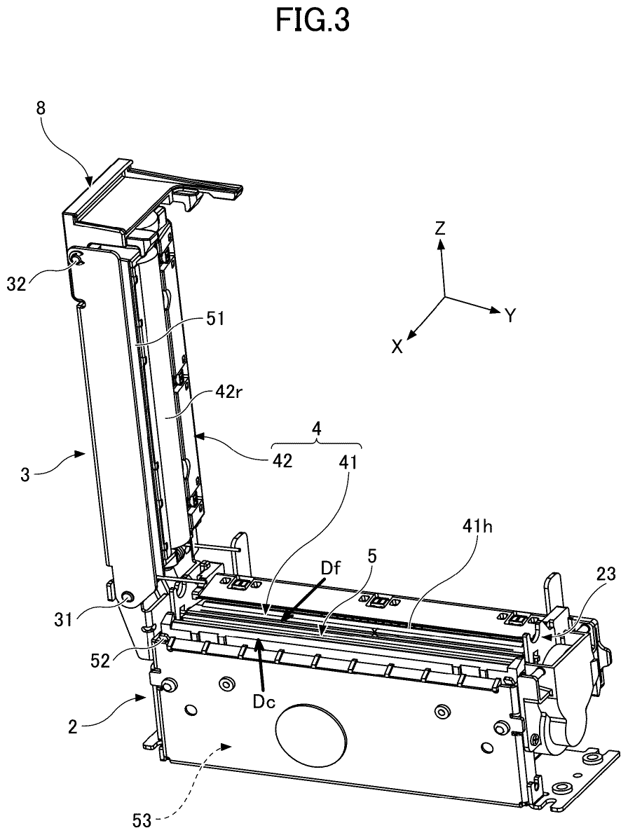

FIG. 1 is a perspective view illustrating a first embodiment of the printer according to the present disclosure. FIGS. 2 and 3 are perspective views illustrating a main body 2 and an openable-closable section 3 of a printer 1 as illustrated in FIG. 1. Each figure is illustrated based on a three-dimensional orthogonal coordinate system in which an X axis is parallel to a conveying direction Df of recording paper P, a Y axis is parallel to the width direction of the recording paper P, and a Z axis is parallel to a cutting direction Dc of the recording paper P.

The printer 1 of the present embodiment is, for example, a thermal printer including a thermal printhead unit 41h, and is used in a multimedia station (MMS), an automatic teller machine (ATM), an automatic cash dispenser (CD), a ticketing machine, a register installed in a convenience store, or the like. The printer 1 is configured to convey the inside thereof, for example, recording paper P, which is thermal paper, and print information such as letters and numerals on the recording paper P, and to cut the recording paper P into pieces to output printed recording paper pieces, such as tickets and receipts.

The printer 1 includes, for example, the main body 2, the openable-closable section 3, a printer section 4, a cutter 5, a base 6, and a recording-paper holder 7. The main body 2 is, for example, a main frame fixed to the base 6, and includes the openable-closable section 3, the printer section 4, the cutter 5, and the like attached to the main body 2.

The openable-closable section 3 is, for example, an openable-closable top portion of the printer 1 disposed above the main body 2 and on a side from which the recording paper P is inserted. In FIG. 2, the openable-closable section 3 provided on the upper side of the main body 2 is fully closed, and in FIG. 3, the openable-closable section 3 is fully open. The openable-closable section 3 has, for example, a rectangular planar shape whose longitudinal direction is the width direction of the recording paper P, which is roll paper.

A rotary shaft 31 is provided at one end of the openable-closable section 3 in the longitudinal direction. The rotary shaft 31 is generally parallel to the conveying direction Df (X-axis direction) of the recording paper P and generally orthogonal to the width direction (Y-axis direction) and the cutting direction Dc (Z-axis direction) of the recording paper P. The openable-closable section 3 is connected to the main body 2 via the rotary shaft 31 inserted through a through hole provided in the main body 2, for example, and is configured to be openable and closable relative to the main body 2 by rotationally moving about the rotary shaft 31.

An opening-closing lever 8 is provided at an end of the openable-closable section 3 on a side opposite to the end connected to the main body 2. The opening-closing lever 8 is rotatably supported, for example, by a rotary shaft 32 provided in the openable-closable section 3. The opening-closing lever 8 is configured to rotationally move between the release position in which the openable-closable section 3 can be opened and closed and the lock position in which the openable-closable section 3 is fixed in a closed state to the main body 2. The opening-closing lever 8 also functions, for example, as a grip when the openable-closable section 3 in the closed state as illustrated in FIGS. 1 and 2 is to be opened like the openable-closable section 3 as illustrated in FIG. 3.

As illustrated in FIG. 3, the printer section 4 includes a head unit 41 configured to print on the recording paper P and a platen 42 configured to convey the recording paper P. In the illustrated example, the head unit 41 is attached to, for example, the main body 2 which is the main frame, and the platen 42 is attached to, for example, the openable-closable section 3. That is, the main body 2 supports the head unit 41 and the openable-closable section 3 supports the platen 42 which is not supported by the main body 2. The main body 2 is provided with a head frame 23 which supports the head unit 41.

Although not illustrated, the arrangement of the head unit 41 and the platen 42 with respect to the main body 2 and the openable-closable section 3 can be reversed. That is, the head unit 41 may be attached to the openable-closable section 3, and the platen 42 may be attached to the main body 2. In this case, the main body 2 supports the platen 42 and the openable-closable section 3 supports the head unit 41 not supported by the main body 2. In this case, a head frame similar to the head frame 23 provided in the main body 2 is provided in the openable-closable section 3 which supports the head unit 41.

The head unit 41 includes, for example, the thermal printhead unit 41h which is a printhead, and the platen 42 includes a platen roller 42r which conveys the recording paper P.

A conveyance drive system such as a motor and a gear which rotates the platen roller 42r of the platen 42 is attached to the main body 2, for example. In the printer 1, for example, by closing the openable-closable section 3, the gear provided on the platen roller 42r becomes connected to the gear of the conveyance drive system attached to the main body 2. The printer section 4 conveys, for example, the recording paper P inserted between the head unit 41 and the platen 42, in the conveying direction Df with the platen roller 42r, and prints on the recording paper P with the thermal printhead unit 41h.

The cutter 5 includes, for example, a fixed blade 51 and a movable blade 52 configured to cut the recording paper P on which printing is performed by the printer section 4, and a cutter driver 53 configured to support and vertically move the movable blade 52. The cutter driver 53 is always connected to the motor and the gear. The fixed blade 51 is disposed along the longitudinal direction of the rectangular openable-closable section 3 and is supported by the openable-closable section 3, for example, as illustrated in FIG. 3. The fixed blade 51 has an elongated shape extending in the width direction of the recording paper P. That is, the longitudinal direction of the fixed blade 51 coincides with the longitudinal direction of the openable-closable section 3.

The movable blade 52 is supported by the main body 2 by attaching the cutter 5 to the main body 2. The movable blade 52 is provided to be movable in the cutting direction Dc, which is an operational direction generally orthogonal to the conveying direction Df of the recording paper P, by the cutter driver 53. The cutter driver 53 includes, for example, the motor, the gear, a mechanical linkage, etc. attached to the main body 2, and is configured to drive the motor to reciprocatingly move the movable blade 52 in the cutting direction Dc and in an opposite direction. The cutter driver 53, for example, moves the movable blade 52 between a standby position before cutting of the recording paper P starts and a completion position at which the cutting of the recording paper P is completed.

As illustrated in FIG. 1, for example, the base 6 is a rectangular plate member that is configured to serve as a base of the printer 1. On the base 6, the main body 2 and the recording-paper holder 7 are disposed adjacent to each other and are fixed to the base 6. The recording-paper holder 7, for example, rotatably supports the recording paper P, which is roll paper, and continuously supplies the recording paper P between the head unit 41 and the platen 42 of the printer section 4.

In the printer 1 of the present embodiment, when the openable-closable section 3 is gradually closed from the state in which it is opened relative to the main body 2, the thermal printhead unit 41h of the head unit 41 and the platen roller 42r of the platen 42 start to contact each other at the end close to the rotary shaft 31 of the openable-closable section 3. Then, when the openable-closable section 3 is further closed relative to the main body 2, a contact range between the thermal printhead unit 41h and the platen roller 42r expands toward the end that is distant from the rotary shaft 31 of the openable-closable section 3 in the width direction of the recording paper P which is the longitudinal direction of the head unit 41.

As described above, when the contact between the head unit 41 and the platen 42 gradually expands in the longitudinal direction of the head unit 41, contact pressure between the platen 42 and the head unit 41 is biased, and the print quality tends to be uneven in the width direction of the recording paper P. Specifically, the closer the contact position is to the rotary shaft 31 of the openable-closable section 3, the greater the contact pressure between the platen 42 and the head unit 41. Therefore, the printer 1 of the present embodiment has a swing supporter of the head unit 41 for uniformly contacting the head unit 41 with the platen 42 when the openable-closable section 3 is closed by rotationally moving the openable-closable section 3 about the rotary shaft 31 orthogonal to the width direction of the recording paper P.

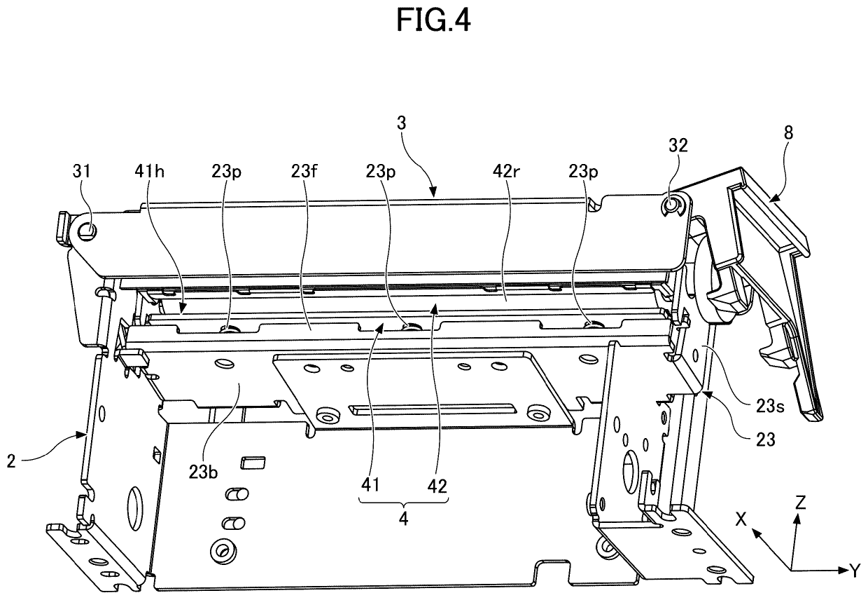

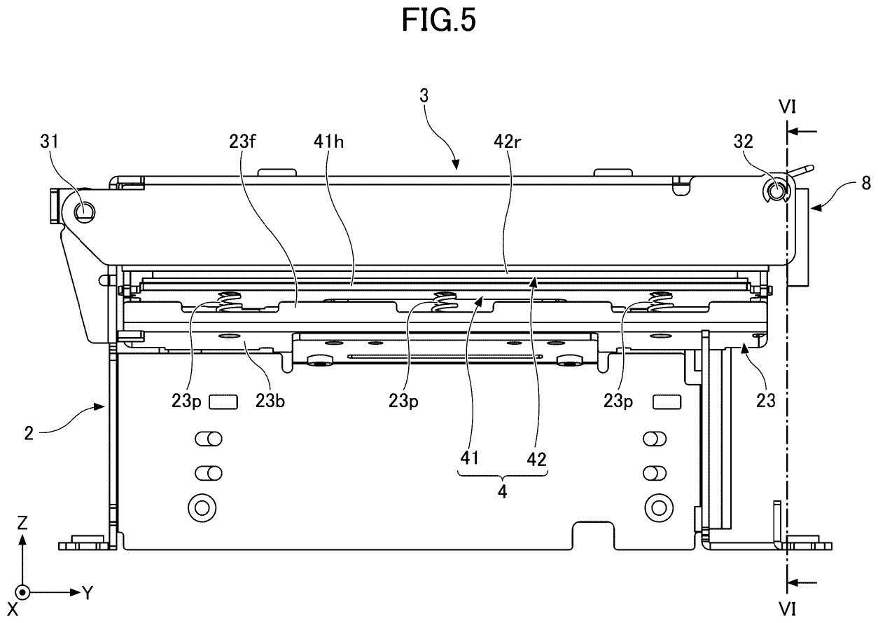

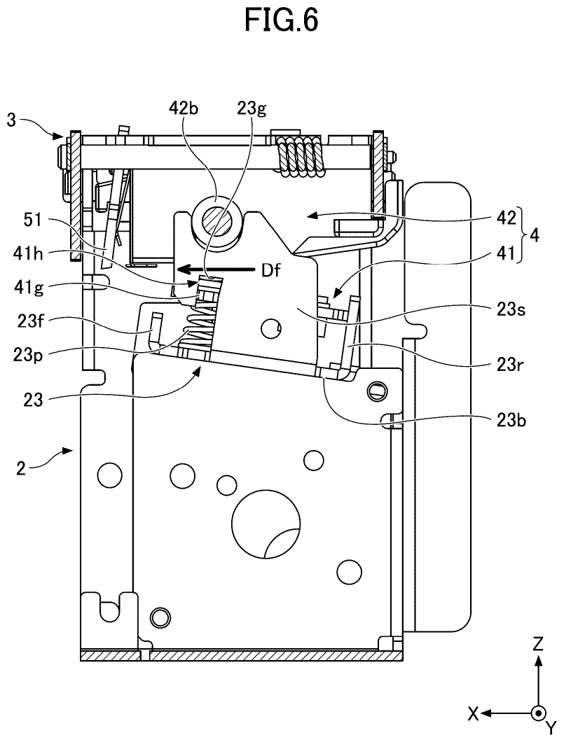

Referring to FIGS. 4 to 12, the swing supporter of the head unit 41, which is a characteristic configuration of the printer 1 of the present embodiment, will be described in detail in the following. FIGS. 4 to 7 are perspective views, front views, cross-sectional views, and front views of the main body 2 and the openable-closable section 3. FIG. 6 is the cross-sectional view of the main body 2 and the openable-closable section 3 taken along a line VI-VI of FIG. 5. In FIGS. 4 to 7, the cutter 5, and also the motor, the gear, or the like configured to drive the printer section 4 and the cutter 5 are not illustrated.

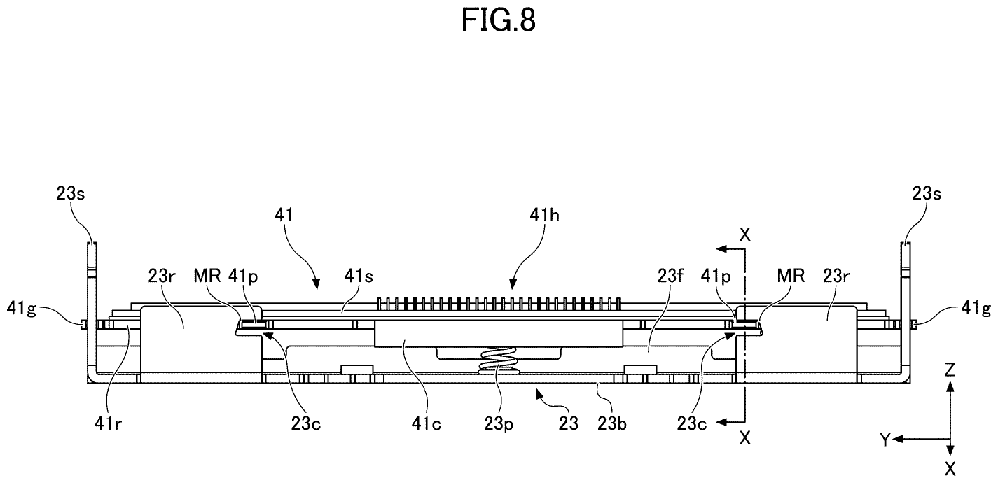

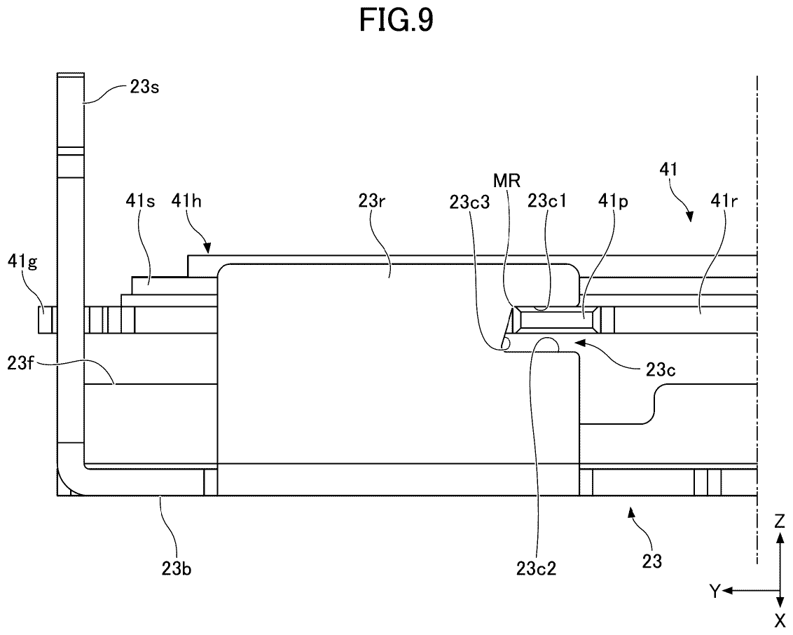

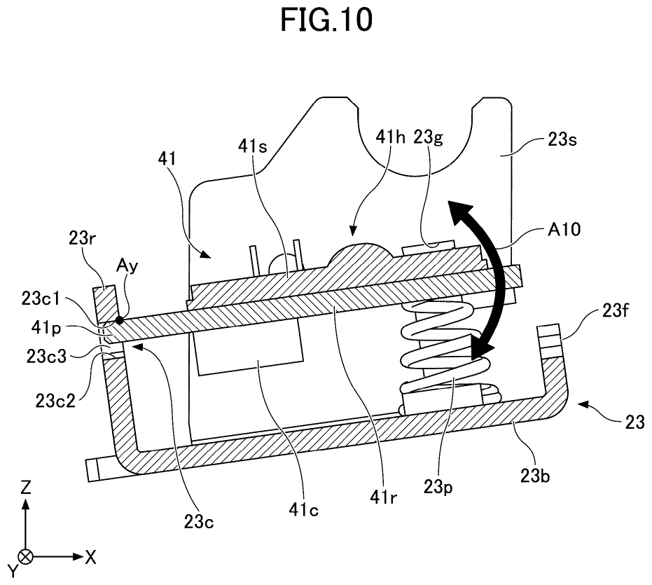

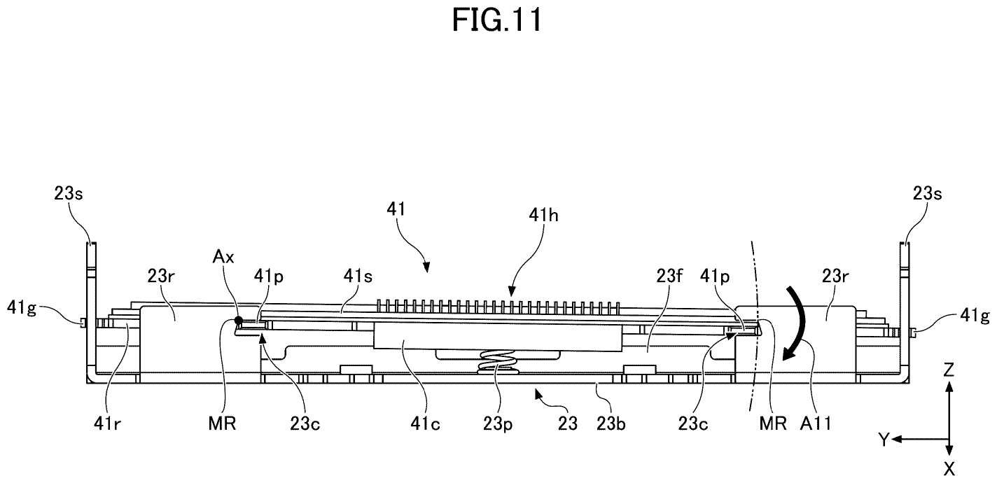

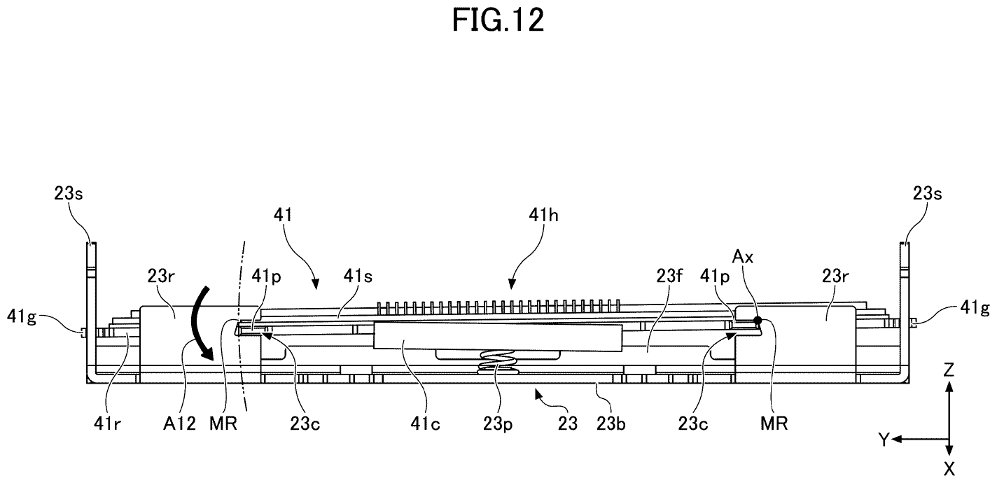

FIG. 8 is the rear view of the head unit 41 and the head frame 23. FIG. 9 is an enlarged view of a projection 41p of the head unit 41 and a notch 23c of the head frame 23. FIG. 10 is the cross-sectional view of the head unit 41 and the head frame 23 taken along an X-X line of FIG. 8. FIGS. 11 and 12 are the rear views of the head unit 41 and the head frame 23 illustrating swinging of the head unit 41 around an Ax-axis parallel to the rotary shaft 31 of the openable-closable section 3.

In the printer 1 of the present embodiment, the swing supporter of the head unit 41 includes a head unit 41 and a head frame 23.

The head unit 41 includes the thermal printhead unit 41h configured to print information such as letters and numerals on the recording paper P. The thermal printhead unit 41h includes, for example, a substrate 41s, a heat sink 41r, and a connector 41c, as illustrated in FIGS. 8 and 10.

The substrate 41s includes, for example, a ceramic substrate and a circuit board. On a surface of the substrate 41s, a heat generating resistor and an integrated circuit (IC) for printing on the recording paper P, which is thermal paper, are mounted. The heat sink 41r is a metal plate member and is fixed to a back surface of the substrate 41s via a double-sided tape or the like. The connector 41c is mounted on the substrate 41s at the center of the head unit 41 in the longitudinal direction (Y-axis direction), and is connected to the heat generating resistor, the IC, and the like of the substrate 41s.

The head unit 41 includes the projections 41p which project toward the rear (X-axis negative direction) in the conveying direction of the recording paper P, and one projection 41p is provided at each of two locations between the center and respective ends of the head unit 41 in the longitudinal direction along the width direction (Y-axis direction) of the recording paper P. In the example as illustrated in FIG. 8, the head unit 41 includes a pair of projections 41p, but the head unit 41 may include three or more projections 41p. The projections 41p are provided, for example, on the heat sink 41r of the thermal printhead unit 41h.

The head unit 41 includes guide projections 41g at both ends in the longitudinal direction (Y-axis direction), for example, as illustrated in FIGS. 6 to 8. The guide projections 41g are provided at the front end of the head unit 41, opposite to the rear end of the head unit 41 provided with the projections 41p in the conveying direction Df of the recording paper P. In the illustrated example, the guide projections 41g are provided on the heat sink 41r.

The head frame 23 includes a bottom wall 23b, side walls 23s, a front wall 23f, and rear walls 23r, for example, as illustrated in FIGS. 6 and 8. The head frame 23 also includes biasing members 23p configured to bias the head unit 41 toward the platen 42.

As illustrated in FIG. 4, for example, the bottom wall 23b is provided on the upper portion of the main body 2 and has a rectangular plate shape in which the width direction (Y-axis direction) of the recording paper P is the longitudinal direction and the conveying direction Df (X-axis direction) of the recording paper P is a transverse direction. As illustrated in FIGS. 6 and 10, the bottom wall 23b is inclined relative to the conveying direction Df of the recording paper P so as to approach the platen 42 from the rear of the conveying direction Df of the recording paper P toward the front.

The side walls 23s are provided so as to rise toward the platen 42 from the longitudinal ends of the bottom wall 23b. For example, as illustrated in FIG. 6, arc-shaped recesses configured to support bearings 42b of the platen roller 42r is provided at the upper ends of the side walls 23s. Also, guide grooves 23g cut toward the platen 42 are provided at the front ends of the side walls 23s in the conveying direction Df of the recording paper P. The guide grooves 23g engage with the guide projections 41g of the head unit 41 and guide the swinging of the head unit 41 around an Ay-axis parallel to the width direction (Y-axis direction) of the recording paper P, as illustrated by an arrow A10 in FIG. 10.

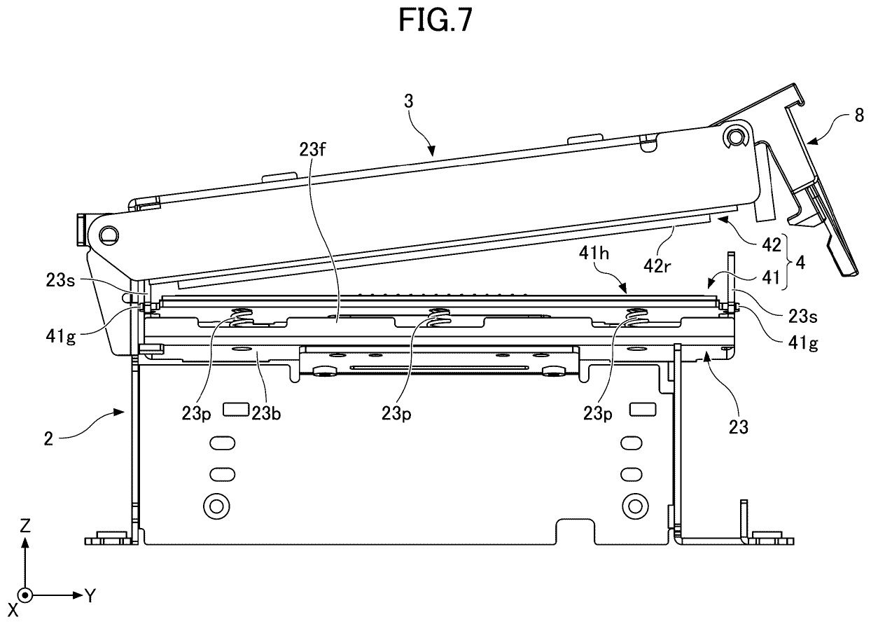

The front wall 23f is provided so as to rise toward the platen 42 from the front end of the bottom wall 23b in the conveying direction Df of the recording paper P. Also, as illustrated in FIG. 7, the front wall 23f is cut in a stepped manner to form notched portions from the upper end toward the bottom wall 23b at a plurality of equally spaced positions in the width direction of the recording paper P. The biasing members 23p are disposed on the rear side in the conveying direction Df of the recording paper P relative to the notched portions of the front wall 23f.

Each of the biasing members 23p is, for example, a spring such as a coil spring, and is disposed between the front end of the heat sink 41r of the head unit 41 in the conveying direction Df of the recording paper P and the bottom wall 23b of the head frame 23. The biasing members 23p bias the front end of the head unit 41 opposite to the rear end of the head unit 41 including the projections 41p toward the platen 42.

The rear walls 23r are disposed so as to stand up toward the platen 42 from the rear end of the bottom wall 23b in the conveying direction Df of the recording paper P. As illustrated in FIG. 8, the rear walls 23r are disposed near the ends in the longitudinal direction (Y-axis direction) of the head frame 23 in the width direction of the recording paper P, and each of the rear walls 23r is provided within the interval between the side wall 23s and at a distance from the side walls 23s. That is, the rear walls 23r generate an opening in the longitudinal center of the head frame 23, at the rear end of the head frame 23 in the conveying direction Df of the recording paper P. Thus, the rear walls 23r expose the connector 41c provided on the thermal printhead unit 41h of the head unit 41 toward the rear side of the conveying direction Df of the recording paper P, in the longitudinal center of the head frame 23.

The rear walls 23r are each provided with the recessed notch 23c cut toward the corresponding end of the head frame 23 in the longitudinal direction, on the side close to the center of the head frame 23 in the longitudinal direction. The notch 23c accommodates the projection 41p of the head unit 41. As illustrated in FIG. 9, the notch 23c includes a space between itself and the projection 41p.

The space between the notch 23c of the head frame 23 and the projection 41p of the head unit 41 allows the head unit 41 to swing around an Ax-axis parallel to the rotary shaft 31 (X-axis direction) of the openable-closable section 3, as illustrated by an arrow A11 in FIG. 11 and an arrow A12 in FIG. 12. The space between the notch 23c of the head frame 23 and the projection 41p of the head unit 41 guides the head unit 41 to swing around the Ay-axis parallel to the width direction (Y-axis direction) of the recording paper P, as illustrated by the arrow A10 in FIG. 10.

In addition, the head frame 23 includes the movement restrictor MR which contacts a part of the head unit 41 from both sides in the longitudinal direction (Y-axis direction) of the head unit 41, for example, as illustrated in FIGS. 8 and 9. In the example as illustrated in FIGS. 8 and 9, the movement restrictor MR includes the notches 23c of the head frame 23 and contacts the projections 41p of the head unit 41 from both sides in the longitudinal direction of the head unit 41.

As illustrated in FIGS. 8 and 9, for example, when the head unit 41 is generally parallel to the width direction of the recording paper P, the movement restrictor MR contacts the projections 41p from both sides in the longitudinal direction of the head unit 41 to restrict movement of the head unit 41 in the longitudinal direction. The movement restrictor MR may be provided at other portions of the head frame 23 and contact other portions of the head unit 41 from both sides in the longitudinal direction of the head unit 41.

As illustrated in FIG. 9, the notch 23c of the head frame 23 includes, for example, a first wall 23cl, a second wall 23c2, and a third wall 23c3.

The first wall 23cl is an inner wall of the notch 23c on the platen 42 side and is provided generally parallel to the width direction of the recording paper P. The first wall 23cl contacts the projection 41p of the head unit 41 in a first state, in which the head unit 41 biased toward the platen 42 by the biasing members 23p is supported in parallel to the width direction of the recording paper P.

The second wall 23c2 is an inner wall of the notch 23c on the side opposite to the platen 42 and is provided generally parallel to the width direction of the recording paper P. The second wall 23c2 is provided to face the first wall 23cl and includes a space between itself and the projection 41p of the head unit 41, in the first state as illustrated in FIGS. 8 and 9.

The third wall 23c3 is the bottom wall of the notch 23c and is provided inclined in the cutting direction Dc (Z-axis direction) of the recording paper P. The third wall 23c3 is provided between the first wall 23cl and the second wall 23c2 with a space between itself and the projection 41p of the head unit 41. Furthermore, as illustrated in FIG. 9, the third wall 23c3 includes an inclined surface which is inclined so as to extend outward in the width direction of the recording paper P as the inclined surface separates from the platen 42, in a direction opposite to a biasing direction of the head unit 41 by the biasing members 23p.

As the third wall 23c3 includes the above-mentioned inclined surface, a space is formed between the projection 41p of the head unit 41 and the third wall 23c3. The space allows the head unit 41 to swing while avoiding interference between the projection 41p and the third wall 23c3, when the head unit 41 swings around an Ax-axis parallel to the conveying direction Df of the recording paper P as illustrated by the arrow A11 in FIG. 11 and the arrow A12 in FIG. 12.

Also, as illustrated in FIG. 9, the end of the third wall 23c3 adjacent to the first wall 23c1 constitutes the movement restrictor MR which restricts the movement of the head unit 41 in the longitudinal direction in the first state. That is, in the present embodiment, the notch 23c contacts the projection 41p while the head unit 41 is supported in parallel to the width direction of the recording paper P to restrict the movement of the head unit 41 in the width direction of the recording paper P. Specifically, the movement restrictor MR is provided between the first wall 23cl and the third wall 23c3 of the notch 23c, and contacts the projection 41p of the head unit 41 in the first state to restrict the movement of the recording paper P in the width direction.

The operation of the printer 1 of the present embodiment will be described in the following.

The printer 1 of the present embodiment includes the head unit 41 configured to print on the recording paper P, the platen 42 configured to convey the recording paper P, the main body 2, the openable-closable section 3, and the head frame 23. The main body 2 is configured to support the head unit 41. The openable-closable section 3 is rotatably connected to the main body 2 about the rotary shaft 31 orthogonal to the width direction of the recording paper P, and supports the platen 42 not supported by the main body 2. The head frame 23 is provided on the main body 2 supporting the head unit 41. The platen 42 may be supported by the main body 2, and the head unit 41 unsupported by the main body 2 may be supported by the openable-closable section 3, and the head frame 23 may be provided on the openable-closable section 3 supporting the head unit 41. The head unit 41 includes the projections 41p which project toward the rear in the conveying direction Df of the recording paper P, with one projection 41p provided at each of two locations between the center and respective ends of the head unit 41 in the longitudinal direction along the width direction of the recording paper P. The head frame 23 includes the notches 23c, each of which accommodates the projection 41p, the movement restrictor MR which contacts a part of the head unit 41 from both sides in the longitudinal direction of the head unit 41, and the biasing members 23p that bias the head unit 41 toward the platen 42. Each of the notches 23c is provided to form a space between itself and the projection 41p, such that the head unit 41 is allowed to swing around the Ax-axis parallel to the rotary shaft 31 and the Ay-axis parallel to the width direction of the recording paper P.

With this configuration, in the printer 1 of the present embodiment, when the openable-closable section 3 is gradually closed from the state in which it is opened with respect to the main body 2, the head unit 41 and the platen 42 start to contact each other at the end near the rotary shaft 31 of the openable-closable section 3. At this time, the head unit 41 biased toward the platen 42 by the biasing members 23p is restricted from moving in a direction away from the rotary shaft 31 by the movement restrictor MR on the left side, which is provided apart from the rotary shaft 31 of the openable-closable section 3, as illustrated in FIG. 11. Furthermore, when the right end of the head unit 41 as illustrated in FIG. 11 near the rotary shaft 31 of the openable-closable section 3 contacts the platen 42, the head unit 41 swings around the Ax-axis parallel to the conveying direction Df of the recording paper P with the movement restrictor MR on the left side as a fulcrum, as illustrated by the arrow A11. As a result, the projection 41p accommodated in the notch 23c on the right side, which is close to the rotary shaft 31 of the openable-closable section 3, moves away from the platen 42, and the head unit 41 is inclined in accordance with the platen 42. Thus, the head unit 41 and the platen 42 contact each other in a state parallel to each other and uniformly in the width direction of the recording paper P.

When the head unit 41 contacts the platen 42, the head unit 41 swings around the Ay-axis parallel to the width direction of the recording paper P with a contact point between the projection 41p and the notch 23c as the fulcrum, as illustrated by the arrow A10 in FIG. 10. Thus, the contact pressure between the head unit 41 and the platen 42 can be adjusted to make the head unit 41 and the platen 42 further uniformly contact.

When the openable-closable section 3 is completely closed with respect to the main body 2, the end of the platen 42 separated from the rotary shaft 31 of the openable-closable section 3 is pushed against the head unit 41. Then, as illustrated in FIG. 12, the movement of the head unit 41 in the direction toward the rotary shaft 31 is restricted by the right movement restrictor MR close to the rotary shaft 31 of the openable-closable section 3. Furthermore, when the left end of the head unit 41 as illustrated in FIG. 12 separated from the rotary shaft 31 is pushed against the platen 42, the head unit 41 swings around the Ax-axis parallel to the conveying direction Df of the recording paper P with the right movement restrictor MR as a fulcrum as illustrated by the arrow A12. As a result, the projection 41p accommodated in the notch 23c on the left side separated from the rotary shaft 31 of the openable-closable section 3 moves away from the platen 42, and the head unit 41 is inclined in accordance with the platen 42. As a result, the head unit 41 and the platen 42 contact each other in parallel and can contact each other uniformly in the width direction of the recording paper P.

Furthermore, when the openable-closable section 3 is fixed to the main body 2 by rotationally moving the opening-closing lever 8 to the lock position with the openable-closable section 3 closed to the main body 2, and the head unit 41 is no longer pushed by the platen 42, the head unit 41 returns to the first state as illustrated in FIG. 8. As a result, the head unit 41 and the platen 42 can contact each other in parallel and can contact each other uniformly in the width direction of the recording paper P. Therefore, according to the printer 1 of the present embodiment, when the openable-closable section 3 is closed to the main body 2, the head unit 41 and the platen 42 always contact each other in a state parallel to each other and uniformly in the width direction of the recording paper P.

Furthermore, as illustrated in FIG. 8, when the connector 41c is provided at the center of the head unit 41 in the longitudinal direction, it is difficult to form a fulcrum for the head unit 41 to swing at the center of the head unit 41 in the longitudinal direction. In addition, when the swing supporter in the width direction of the recording paper P is formed by using shafts, pins, etc., the cost of parts and the like increases. In contrast to this, in the printer 1 of the present embodiment, the head unit 41 is swung by providing the projections 41p between the center and respective ends of the head unit 41 in the longitudinal direction, and supporting the projections 41p by the notches 23c of the head frame 23. Thus, the head unit 41 can be swung while avoiding interference with the connector 41c provided at the center of the head unit 41 in the longitudinal direction. In addition, since no shaft or pin is used to support swinging of the head unit 41, the cost of parts and the like can be suppressed.

In the printer 1 of the present embodiment, each notch 23c of the head frame 23 includes the first wall 23cl, the second wall 23c2, and the third wall 23c3. The first wall 23c1 contacts the projection 41p in the first state in which the head unit 41 is supported in parallel to the width direction of the recording paper P. The second wall 23c2 is provided to face the first wall 23cl and to form a space between itself and the projection 41p in the first state. The third wall 23c3 is provided between the first wall 23cl and the second wall 23c2 and is provided with a space between itself and the projection 41p.

With this configuration, the space between the second wall 23c2 and the projection 41p as illustrated in FIG. 9 and the space between the third wall 23c3 and the projection 41p allows the head unit 41 to swing around the Ax-axis parallel to the conveying direction Df of the recording paper P, as illustrated by the arrow A11 in FIG. 11 and the arrow A12 in FIG. 12. In addition, the space between the second wall 23c2 and the projection 41p as illustrated in FIG. 9 allows the head unit 41 to swing around the Ay-axis parallel to the conveying direction of the recording paper P, as illustrated by the arrow A10 in FIG. 10.

In addition, in the printer 1 of the present embodiment, the third wall 23c3 of the notch 23c includes, as illustrated in FIG. 9, an inclined surface which is inclined so as to expand outward in the width direction of the recording paper P as it separates from the platen 42 in the direction opposite to the biasing direction of the head unit 41 by the biasing members 23p.

With this configuration, for example, when the end surface of the projection 41p facing the third wall 23c3 is perpendicular to the longitudinal direction of the head unit 41, as illustrated in FIG. 9, a space can be formed between the third wall 23c3 and the projection 41p. By forming such a space between the third wall 23c3 and the projection 41p, the head unit 41 is allowed to swing around the Ax-axis parallel to the conveying direction Df of the recording paper P, as illustrated by the arrow A11 in FIG. 11 and the arrow A12 in FIG. 12.

In the printer 1 of the present embodiment, the movement restrictor MR is provided between the first wall 23cl and the third wall 23c3 of the notch 23c, and contacts the projection 41p of the head unit 41 in the first state as illustrated in FIGS. 8 and 9 to restrict the movement of the recording paper P in the width direction.

With this configuration, in the first state where the head unit 41 is parallel to the width direction of the recording paper P, the notches 23c are made to function as the movement restrictor MR to restrict the movement of the head unit 41 in the longitudinal direction. Thus, as illustrated in FIGS. 11 and 12, the head unit 41 can swing around the Ax-axis parallel to the conveying direction Df of the recording paper P with the movement restrictor MR as the fulcrum.

In the printer 1 of the present embodiment, the head unit 41 includes the guide projections 41g at both ends in the longitudinal direction as illustrated in FIG. 8. Also, as illustrated in FIGS. 6 and 10, the head frame 23 includes the guide grooves 23g configured to guide the swinging of the head unit 41 around the Ay-axis parallel to the width direction of the recording paper P by engaging with the guide projections 41g.

With this configuration, the guide projections 41g of the head unit 41 can be engaged with the guide grooves 23g of the head frame 23 to restrict the movement of the head unit 41 in the conveying direction Df of the recording paper P. Thus, the head unit 41 can be stably swung around the Ay-axis parallel to the width direction of the recording paper P. The guide projections 41g of the head unit 41 that swings around the Ax-axis parallel to the conveying direction Df of the recording paper P are guided by the guide grooves 23g of the head frame 23. Thus, the swinging of the head unit 41 around the Ax-axis parallel to the conveying direction Df of the recording paper P can be stabilized.

Furthermore, as described above, the printer 1 of the present embodiment includes the head unit 41 configured to print on the recording paper P, the platen 42 configured to convey the recording paper P, the main body 2, the openable-closable section 3, and the head frame 23. The main body 2 supports the head unit 41 or the platen 42. The openable-closable section 3 is rotatably connected to the main body 2 about the rotary shaft 31 orthogonal to the width direction of the recording paper P, and supports the platen 42 or the head unit 41 unsupported by the main body 2. The head frame 23 is provided on the main body 2 or on the openable-closable section 3 configured to support the head unit 41. The head unit 41 includes the projections 41p which project toward the rear in the conveying direction Df of the recording paper P and with one projection 41p provided at each of two locations between the center and respective ends of the head unit 41 in the longitudinal direction along the width direction of the recording paper P. The head frame 23 includes the notches 23c configured to accommodate the projections 41p and the biasing members 23p configured to bias the head unit 41 toward the platen 42. Each of the notches 23c is provided to form a space between the notch and the projection 41p for allowing the head unit 41 to swing around the Ax-axis parallel to the rotary shaft 31 and around the Ay-axis parallel to the width direction of the recording paper P. In addition, the notch 23c contacts the projection 41p while the head unit 41 is supported in parallel to the width direction of the recording paper P to restrict the movement of the head unit 41 in the width direction of the recording paper P.

With this configuration, in the printer 1 of the present embodiment, when the openable-closable section 3 is gradually closed from the state in which it is opened with respect to the main body 2, the head unit 41 and the platen 42 start to contact each other at the end near the rotary shaft 31 of the openable-closable section 3. At this time, the head unit 41, which is biased toward the platen 42 by the biasing members 23p, is restricted from moving away from the rotary shaft 31 by the notch 23c on the left side of the openable-closable section 3, which is separated from the rotary shaft 31, as illustrated in FIG. 11. Furthermore, as illustrated in FIG. 11, when the right end of the head unit 41 near the rotary shaft 31 of the openable-closable section 3 contacts the platen 42, the head unit 41 swings around the Ax-axis parallel to the conveying direction Df of the recording paper P with the contact point between the notch 23c on the left side and the projection 41p on the left side as the fulcrum, as illustrated by the arrow A11. As a result, the projection 41p accommodated in the notch 23c on the right side near the rotary shaft 31 of the openable-closable section 3 moves away from the platen 42, and the head unit 41 is inclined in accordance with the platen 42. Thus, the head unit 41 and the platen 42 contact each other in a state parallel to each other and uniformly in the width direction of the recording paper P.

When the head unit 41 contacts the platen 42, the head unit 41 swings around the Ay-axis parallel to the width direction of the recording paper P with the contact point between the projection 41p and the notch 23c as the fulcrum, as illustrated by the arrow A10 in FIG. 10. Thus, the contact pressure between the head unit 41 and the platen 42 can be adjusted to make the head unit 41 and the platen 42 further uniformly contact.

When the openable-closable section 3 is completely closed with respect to the main body 2, the end of the platen 42 separated from the rotary shaft 31 of the openable-closable section 3 is pushed against the head unit 41. Then, as illustrated in FIG. 12, the movement of the head unit 41 in the direction toward the rotary shaft 31 is restricted by the right-side notch 23c close to the rotary shaft 31 of the openable-closable section 3. Furthermore, when the left end of the head unit 41 separated from the rotary shaft 31 of the openable-closable section 3, as illustrated in FIG. 12, is pushed against the platen 42, the head unit 41 swings around the Ax-axis parallel to the conveying direction Df of the recording paper P with the contact point between the right-side notch 23c and the right-side projection 41p as the fulcrum, as illustrated by the arrow A12. As a result, the projection 41p accommodated in the left-side notch 23c separated from the rotary shaft 31 of the openable-closable section 3 moves away from the platen 42, and the head unit 41 is inclined in accordance with the platen 42. Thus, the head unit 41 and the platen 42 contact each other in a state parallel to each other and uniformly in the width direction of the recording paper P.

When the openable-closable section 3 is fixed to the main body 2 by rotationally moving the opening-closing lever 8 to the lock position while the openable-closable section 3 is closed to the main body 2, and the head unit 41 is no longer pushed by the platen 42, the head unit 41 returns to the first state as illustrated in FIG. 8. Thus, the head unit 41 and the platen 42 contact each other in a state parallel to each other and uniformly in the width direction of the recording paper P. Therefore, according to the printer 1 of the present embodiment, when the openable-closable section 3 is closed relative to the main body 2, the head unit 41 and the platen 42 always contact each other in a state parallel to each other and uniformly in the width direction of the recording paper P.

As described above, according to the present embodiment, when the openable-closable section 3 is rotatably connected to the main body 2 about the rotary shaft 31 orthogonal to the width direction of the recording paper P so as to be openable and closable relative to the main body 2, it is possible to provide the printer 1 capable of bringing the head unit 41 and the platen 42 into contact uniformly in the width direction of the recording paper P.

### Second Embodiment

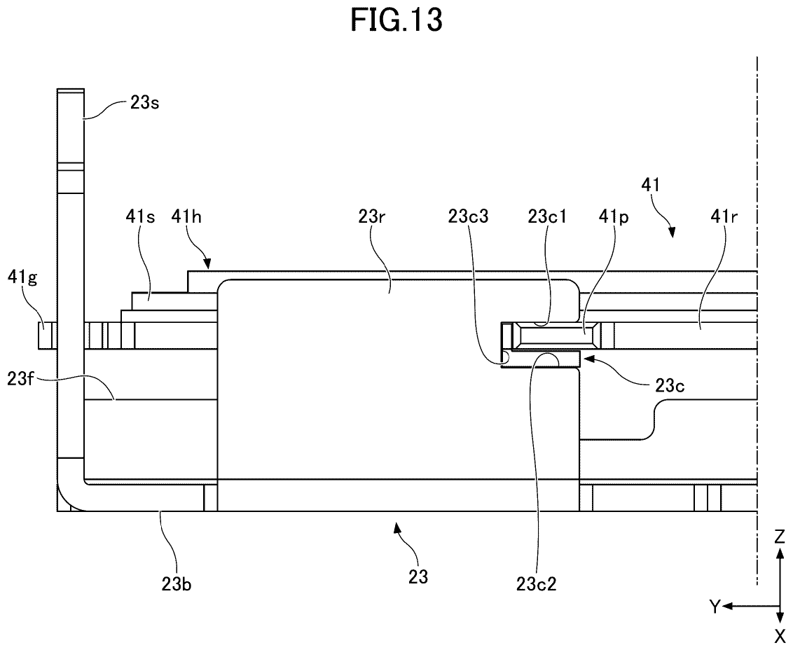

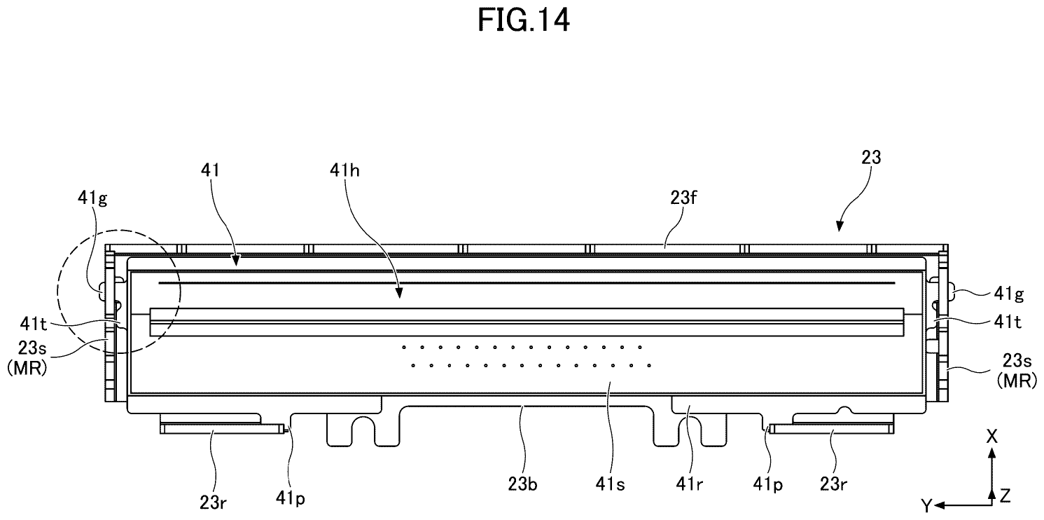

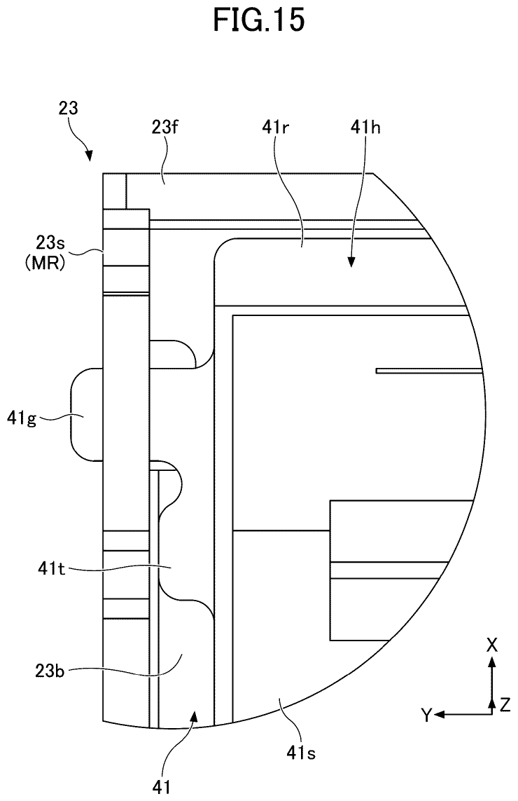

Next, a second embodiment of a printer according to the present disclosure will be described with reference to FIGS. 13 to 15. FIG. 13 is an enlarged view of the projection 41p and the notch 23c of the printer 1 according to the second embodiment. FIG. 14 is a top view of the head unit 41 and the platen 42 of the printer 1 according to the present embodiment. FIG. 15 is an enlarged view of a projecting portion 41t of the head unit 41 and the side wall 23s of the head frame 23.

The printer 1 of the present embodiment is different from the printer 1 of the first embodiment described above in that a projecting portion 41t is provided at each end of the head unit 41 in the longitudinal direction, and the movement restrictor MR for restricting movement of the head unit 41 in the longitudinal direction is the side walls 23s of the head frame 23 that contact the projecting portions 41t of the head unit 41. Since the other configuration of the printer 1 of the present embodiment is the same as that of the printer 1 of the first embodiment described above, similar components are denoted by the same reference numerals and descriptions thereof are omitted.

As illustrated in FIG. 13, in the printer 1 of the present embodiment, the third wall 23c3 of the notch 23c is parallel to the cutting direction Dc (Z-axis direction) of the recording paper P. Therefore, in the first state in which the head unit 41 biased toward the platen 42 by the biasing members 23p is parallel to the width direction of the recording paper P, the third wall 23c3 of the notch 23c and the projections 41p do not contact, and a space is formed between the third wall 23c3 and the projection 41p. Therefore, the notch 23c cannot restrict the longitudinal movement of the head unit 41 in the first state of the head unit 41.

In contrast to this, as illustrated in FIGS. 14 and 15, the projecting portion 41t is provided at each longitudinal end of the head unit 41. The projecting portions 41t are provided, for example, on the heat sink 41r and adjacent to the rear side of the guide projections 41g in the conveying direction Df (X-axis direction) of the recording paper P. The tip of the projecting portion 41t contacts the inner surface of the side wall 23s provided at each longitudinal end of the head frame 23.

In the printer 1 of the present embodiment, the side walls 23s of the head frame 23 contact the projecting portions 41t of the head unit 41 from both sides in the longitudinal direction of the head unit 41 and function as the movement restrictor MR for restricting movement of the head unit 41 in the longitudinal direction. That is, in the present embodiment, the movement restrictor MR configured to restrict movement of the head unit 41 in the longitudinal direction is the side walls 23s of the head frame 23 which contact the projecting portions 41t provided at the ends in the longitudinal direction of the head unit 41.

More specifically, the printer 1 of the present embodiment includes the head unit 41 configured to print on the recording paper P, the platen 42 configured to convey the recording paper P, the main body 2, the openable-closable section 3, and the head frame 23. The main body 2 supports the head unit 41 or the platen 42. The openable-closable section 3 is connected to the main body 2 to be rotationally movable about the rotary shaft 31 orthogonal to the width direction of the recording paper P, and supports the platen 42 or the head unit 41 not supported by the main body 2. The head frame 23 is provided on the main body 2 or the openable-closable section 3 configured to support the head unit 41. The head unit 41 includes the projections 41p which project toward the rear in the conveying direction Df of the recording paper P, and with one projection 41p provided at each of two locations between the center and respective ends of the head unit in the longitudinal direction along the width direction of the recording paper P, and the projecting portions 41t provided at the ends in the longitudinal direction of the head unit 41. The head frame 23 includes the notches 23c configured to accommodate the projections 41p, the side walls 23s that contact the projecting portions 41t from both sides in the longitudinal direction of the head unit 41, and the biasing members 23p configured to bias the head unit 41 toward the platen 42. Each of the notches 23c is provided to form a space between the notch walls and the projection 41p for allowing the head unit 41 to swing around the Ax-axis parallel to the rotary shaft 31 and around the Ay-axis parallel to the width direction of the recording paper P.

With this configuration, even when the notches 23c of the head frame 23 do not function as the movement restrictor MR, the side walls 23s of the head frame 23 function as the movement restrictor MR to restrict the movement of the head unit 41 in the longitudinal direction. Therefore, according to the present embodiment, it is possible to provide the printer 1 in which the head unit 41 and the platen 42 uniformly contact in the width direction of the recording paper P, similar to the above-described first embodiment.

### Third Embodiment

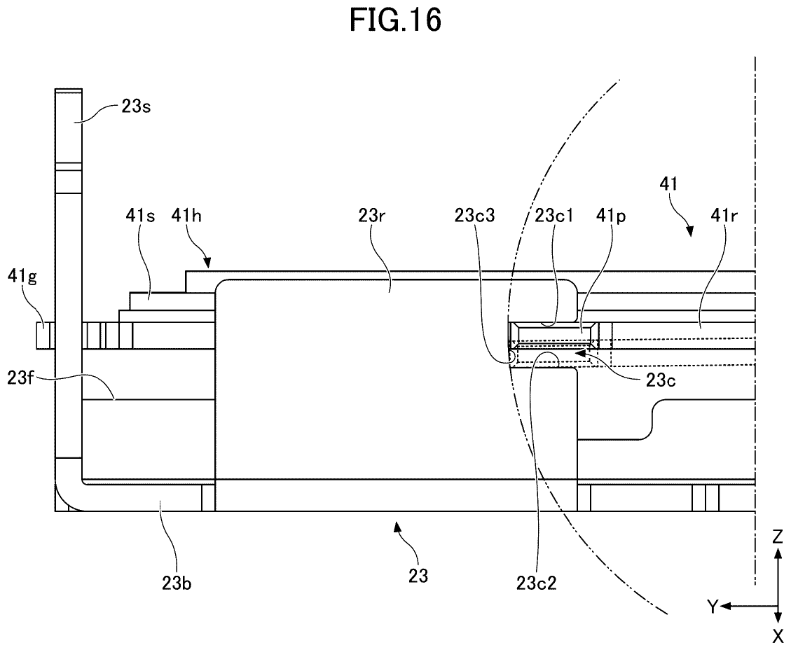

Next, a third embodiment of a printer according to the present disclosure will be described with reference to FIG. 16. FIG. 16 is an enlarged view of the projection 41p and the notch 23c of the printer 1 according to the third embodiment.

The printer 1 according to the present embodiment is different from the printer 1 according to the above-described first embodiment in that the third wall 23c3 of the notch 23c of the head frame 23 has an arcuate shape to allow the head unit 41 to swing around the Ax-axis parallel to the rotary shaft 31 of the openable-closable section 3. Since the other configuration of the printer 1 of the present embodiment is the same as that of the printer 1 of the first embodiment, the same reference numerals are attached to the similar components and descriptions thereof are omitted.

With this configuration, the printer 1 of the present embodiment can avoid interference between the third wall 23c3 and the projection 41p in the notch 23c and allow the head unit 41 to swing around the Ax-axis parallel to the rotary shaft 31 of the openable-closable section 3, as in the printer 1 of the first embodiment. Therefore, the printer 1 of the present embodiment can provide the printer 1 in which the head unit 41 and the platen 42 uniformly contact each other in the width direction of the recording paper P, as in the case of the first embodiment.

### Fourth Embodiment

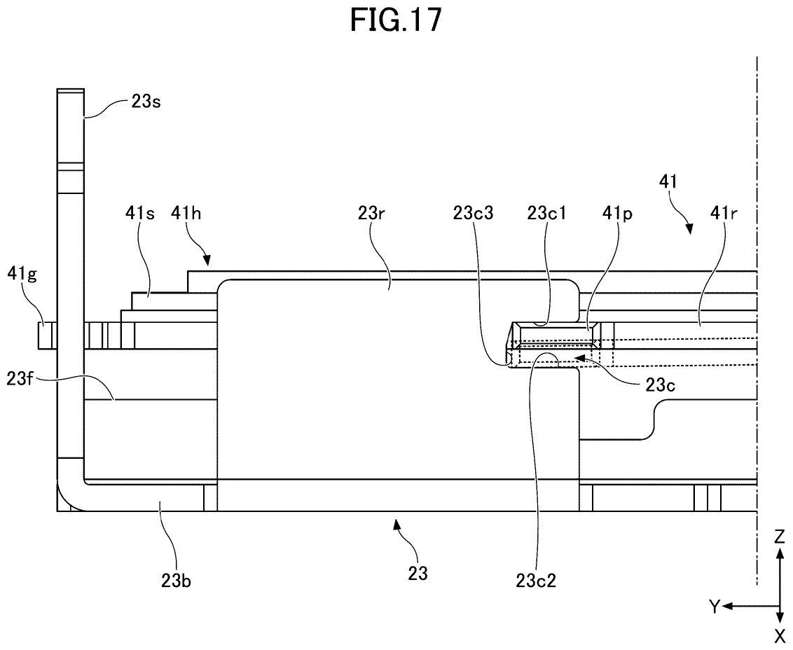

Next, a fourth embodiment of a printer according to the present disclosure will be described with reference to FIG. 17. FIG. 17 is an enlarged view of the projection 41p and the notch 23c of the printer 1 of the fourth embodiment.

The printer 1 of the present embodiment differs from the printer 1 of the first embodiment in that the third wall 23c3 of the notch 23c of the head frame 23 includes not only an inclined surface inclined with respect to the biasing direction of the head unit 41 by the biasing members 23p, but also a flat surface. Since the other configuration of the printer 1 of the present embodiment is the same as that of the printer 1 of the first embodiment, the same reference numerals are attached to the similar components and descriptions thereof are omitted.

As illustrated in FIG. 17, in the printer 1 of the present embodiment, the third wall 23c3 of the notch 23c includes an inclined surface as in the printer 1 of the first embodiment. The inclined surface is inclined so as to expand outward in the width direction (Y-axis direction) of the recording paper P as it separates from the platen 42 in the direction opposite to the biasing direction (Z-axis positive direction) of the head unit 41 by the biasing members 23p. Moreover, the third wall 23c3 includes a flat surface along the biasing direction of the head unit 41 by the biasing members 23p between the inclined surface and the second wall 23c2.

According to the printer 1 of the present embodiment, as in the printer 1 of the first embodiment, in the notch 23c, the interference between the third wall 23c3 and the projection 41p is avoided, and swinging of the head unit 41 around the Ax-axis parallel to the rotary shaft 31 of the openable-closable section 3 is allowed. Therefore, according to the present embodiment, as in the first embodiment described above, it is possible to provide the printer 1 capable of uniformly contacting the head unit 41 and the platen 42 in the width direction of the recording paper P.

All examples and conditional language provided herein are intended for the purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A printer, comprising:
a head unit configured to print on recording paper;
a platen configured to convey the recording paper;
a main body configured to support the head unit or the platen;
an openable-closable section connected to the main body to be rotationally movable about a rotary shaft orthogonal in a width direction of the recording paper and configured to support the platen or the head unit unsupported by the main body; and
a head frame provided on the main body or the openable-closable section configured to support the head unit, wherein
the head unit includes
a plurality of projections which project toward a rear in a conveying direction of the recording paper, and with one projection provided at each location between a center and respective ends of the head unit in a longitudinal direction along the width direction of the recording paper,
the head frame includes
a notch configured to accommodate the projection;
a movement restrictor configured to contact a part of the head unit from both sides in the longitudinal direction; and
a biasing member configured to bias the head unit toward the platen, and
the notch is provided to form a space between itself and the projection to allow swinging of the head unit around an axis parallel to the rotary shaft and around an axis parallel to the width direction of the recording paper.

2. The printer according to claim 1, wherein
the notch includes
a first wall configured to contact the projection in a first state in which the head unit is supported in parallel to the width direction of the recording paper;
a second wall provided to face the first wall and to form a space between itself and the projection in the first state; and
a third wall provided between the first wall and the second wall and with a space between itself and the projection.

3. The printer according to claim 2, wherein
the third wall of the notch includes an inclined surface which is inclined so as to extend outward in the width direction of the recording paper as the inclined surface separates from the platen, in a direction opposite to a biasing direction of the head unit by the biasing member.

4. The printer according to claim 3, wherein
the movement restrictor is provided between the first wall and the third wall of the notch, and contacts the projection of the head unit in the first state to restrict movement of the recording paper in the width direction.

5. The printer according to claim 2, wherein
the third wall of the notch has an arcuate shape to allow the head unit to swing around an axis parallel to the rotary shaft.

6. The printer according to claim 1, wherein
the movement restrictor is side walls of the head frame which contact projecting portions provided at ends in the longitudinal direction of the head unit.

7. The printer according to claim 1, wherein
the head unit includes guide projections at the ends in the longitudinal direction, and
the head frame includes guide grooves configured to guide swinging of the head unit around the axis parallel to the width direction of the recording paper by engaging with the guide projections.

8. A printer, comprising:
a head unit configured to print on recording paper;
a platen configured to convey the recording paper;
a main body configured to support the head unit or the platen;
an openable-closable section connected to the main body to be rotationally movable about a rotary shaft orthogonal in a width direction of the recording paper and configured to support the platen or the head unit unsupported by the main body; and
a head frame provided on the main body or the openable-closable section configured to support the head unit, wherein
the head unit includes a plurality of projections which project toward a rear in a conveying direction of the recording paper, and with one projection provided at each location between a center and respective ends of the head unit in a longitudinal direction along the width direction of the recording paper,
the head frame includes
a notch configured to accommodate the projection; and
a biasing member configured to bias the head unit toward the platen, and
the notch is provided to form a space between itself and the projection to allow swinging of the head unit around an axis parallel to the rotary shaft and around an axis parallel to the width direction of the recording paper, and is configured to restrict movement of the head unit in the width direction of the recording paper by contacting the projection in a state where the head unit is supported in parallel to the width direction of the recording paper.

9. A printer, comprising:
a head unit configured to print on recording paper;
a platen configured to convey the recording paper;
a main body configured to support the head unit or the platen;
an openable-closable section connected to the main body to be rotationally movable about a rotary shaft orthogonal in a width direction of the recording paper and configured to support the platen or the head unit unsupported by the main body; and
a head frame provided on the main body or the openable-closable section configured to support the head unit, wherein
the head unit includes
a plurality of projections which project toward a rear in a conveying direction of the recording paper, and with one projection provided at each location between a center and respective ends of the head unit in a longitudinal direction along the width direction of the recording paper; and
a plurality of projecting portions provided on the ends of the head unit in a longitudinal direction,
the head frame includes
a notch configured to accommodate the projection;
a side wall configured to contact the projecting portion from each side in the longitudinal direction; and
a biasing member configured to bias the head unit toward the platen, and
the notch is provided to form a space between itself and the projection to allow swinging of the head unit around an axis parallel to the rotary shaft and around an axis parallel to the width direction of the recording paper.
